(19) United States
(12) Patent Application Publication
(10) Pub. No.: US 2010/0061638 A1
(43) Pub. Date: Mar. 11, 2010

(54) INFORMATION PROCESSING APPARATUS, INFORMATION PROCESSING METHOD, AND COMPUTER-READABLE STORAGE MEDIUM

(76) Inventor: Yasuyuki Tanaka, Akishima-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/619,432

(22) Filed: Nov. 16, 2009

Related U.S. Application Data
(63) Continuation-in-part of application No. 12/392,881, filed on Feb. 25, 2009.

(30) Foreign Application Priority Data
Aug. 29, 2008 (JP) 2008-221474
Jul. 31, 2009 (JP) 2009-179684

(51) Int. Cl. G06K 9/48

(52) U.S. Cl. 382/199; 382/266; 382/299

(57) ABSTRACT

According to one embodiment, an information processing apparatus comprises producing temporary high-resolution image data of a second resolution based on image data of the first resolution, setting a predetermined number of pixels in the image data of the first resolution as target pixels, performing a self-congruity point extraction processing for searching for corresponding points in image regions which approximate a change pattern of pixel values of a target region including the target pixel from the image data of the first resolution, performing a sharpness enhancement processing for the temporary high-resolution image based on the target pixel, and a controller configured to control the processor not to perform the self-congruity point extraction processing and the sharpness enhancement processing when a detected edge is one of vertical and horizontal edges.

### CROSS-REFERENCE TO RELATED APPLICATIONS

This is a Continuation-in-Part application of U.S. patent application Ser. No. 12/392,881, filed Feb. 25, 2009, the entire contents of which are incorporated herein by reference.

This application is based upon and claims the benefit of priority from Japanese Patent Applications No. 2008-221474, filed Aug. 29, 2008; and No. 2009-179684, filed Jul. 31, 2009, the entire contents of both of which are incorporated herein by reference.

### BACKGROUND

1. Field

One embodiment of the present invention relates to an information processing apparatus, an information processing apparatus, and a computer-readable storage medium for performing a super-resolution processing, and in particular to an information processing apparatus, an information processing apparatus, and a computer-readable storage medium capable of reducing processing load of the super-resolution processing.

2. Description of the Related Art

Generally, in an apparatus such as a personal computer or a television set, a display apparatus is capable of displaying an image with a high resolution, such as a high-definition resolution. On the other hand, regarding a content source, there are many content sources with a low resolution lower than the resolution of the display apparatus. Therefore, needs for a technology that, even if a content from these content sources with a low resolution is reproduced in the above-mentioned display apparatus with a high resolution, reproduction can be performed with a quality close to that of a content from the content sources with a high resolution are increasing. For example, Jpn. Pat. Appln. KOKAI Publication No. 2007-305113 discloses a technology of producing a content with a high resolution from a content source with a low resolution utilizing image processing.

In the technology disclosed in Jpn. Pat. Appln. KOKAI Publication No. 2007-305113, however, since processing for achieving a high resolution is applied to all pixel data contained in the content with a low resolution, such a problem arises that load for the processing is large.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a hardware configuration of an information processing apparatus according to an embodiment of the present invention;

FIG. 2 is an exemplary block diagram showing a functional configuration of the information processing apparatus according to the embodiment;

FIG. 3 is an exemplary flowchart showing a super-resolution processing performed by the information processing apparatus according to the embodiment;

FIG. 4 is an exemplary flowchart showing an edge determination processing in the super-resolution processing according to the embodiment;

FIG. 5 is an exemplary diagram conceptually showing frames of video data input to the information processing apparatus according to the embodiment;

FIG. 6 is an exemplary diagram conceptually showing pixel within a reference frame of the video data input to the information processing apparatus according to the embodiment;

FIG. 7 is an exemplary diagram conceptually showing an edge determination using pixels of 3×3 according to the embodiment;

FIG. 8 is an exemplary diagram conceptually showing angles on which pixels are arranged according to the embodiment;

FIG. 9 is an exemplary diagram conceptually showing parameters for a super-resolution processing using pixels of 3×3 according to the embodiment;

FIG. 10 is an exemplary diagram conceptually showing an edge determination using pixels of 5×5 according to the embodiment;

FIG. 11 is an exemplary diagram conceptually showing parameters for a super-resolution achievement processing using pixels of 5×5 according to the embodiment;

FIG. 12 is an exemplary flowchart illustrating the procedure of a super-resolution processing performed by the information processing apparatus according to the embodiment;

FIG. 13 is an exemplary flowchart illustrating an edge determination in the super-resolution processing of FIG. 12;

FIG. 14 is an exemplary flowchart for illustrating the procedure of the edge determination in the super-resolution processing of FIG. 12;

FIG. 15 is an exemplary view showing a temporary high-resolution image produced by the information processing apparatus according to the embodiment;

FIGS. 16A and 16B are exemplary views illustrating edge angles detected by the information processing apparatus according to the embodiment;

FIG. 17 is an exemplary view illustrating a sharpness enhancement performed by the information processing apparatus according to the embodiment;

FIG. 18 is an exemplary view illustrating a plurality of sampled values used in the sharpness enhancement performed by the information processing apparatus according to the embodiment;

FIG. 19 is an exemplary view for illustration an edge angle detection performed by the information processing apparatus according to the embodiment; and

FIG. 20 is an exemplary diagram showing the relation between the edge angle and the content of the sharpness enhancement processing performed by the information processing apparatus according to the embodiment.

### DETAILED DESCRIPTION

Various embodiments according to the invention will be described hereinafter with reference to the accompanying drawings. In general, according to one embodiment of the invention, an information processing apparatus comprises a processor configured to produce temporary high-resolution image data of a second resolution higher than a first resolution based on image data of the first resolution, to sequentially set a predetermined number of pixels in the image data of the first resolution as target pixels one by one, to detect an edge of each target pixel, to perform a self-congruity point extraction processing for searching for corresponding points in image regions which approximate a change pattern of pixel values of a target region including the target pixel from the image data of the first resolution when the edge is detected, and to perform a sharpness enhancement processing for the temporary high-resolution image based on the target pixel of which edge is detected and corresponding points corresponding to each target pixel of which edge is detected; and a controller configured to control the processor not to perform the self-congruity point extraction processing and the sharpness enhancement processing when a detected edge is one of vertical and horizontal edges.

Embodiments of the present invention will be explained below with reference to the drawings.

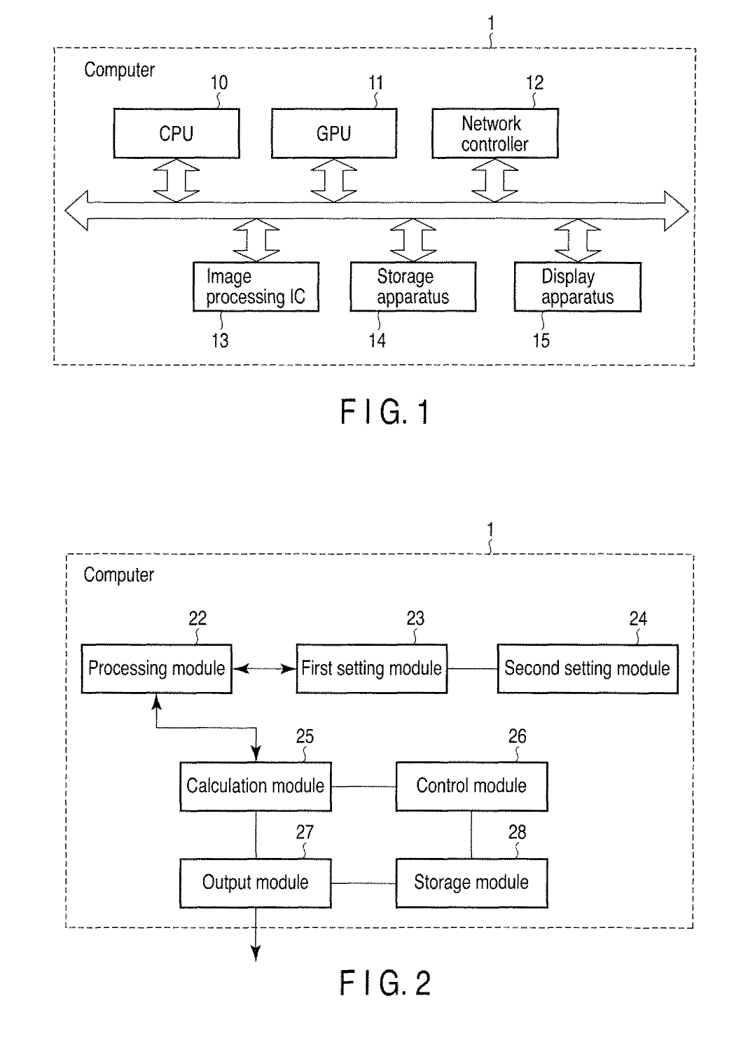

Referring to FIG. 1, first, a configuration of an information processing apparatus according to an embodiment of the present invention will be explained.

The information processing apparatus is accomplished as a personal computer 1, for example. The computer 1 comprises a central processing unit (CPU) 10, a graphics processing unit (GPU) 11, a network controller 12, an image processing IC 13, a storage apparatus (HDD) 14, a display apparatus (liquid crystal display (LCD)) 15, and the like.

The CPU 10 is a processor provided for controlling an operation of the computer, and it executes an operating system (OS) and various application programs loaded from a storage apparatus (HOD) 14 to a main memory.

The CPU 10 executes a system Basic Input-Output System (BIOS) stored in a BIOS-ROM (not shown) included in the CPU 10. The system BIOS is a program for hardware control.

The GPU 11 is a display controller for controlling the LCD 15 used as a display monitor of the computer. The GPU 11 produces display signals to be supplied to the LCD 15 from image data stored in a video memory (VRAM) (not shown) included in the GPU 11.

The network controller 12 is a controller device for controlling transmission and reception of data between the network controller 12 and an external network such as a local area network (LAN) or the Internet.

The image processing IC (processing module) 13 is a dedicated IC for an image processing including a coding processing, a decoding processing, a super-resolution processing of input image signals or the like. The super-resolution processing includes an edge determination processing, a self-congruity point search processing (self-congruency extraction processing or self-congruity point extraction processing), a sharpness enhancement processing, a temporary high-resolution image production processing, and the like. It should be noted that when the computer 1 does not include the image processing IC 13, processing to be performed by the image processing IC 13 may be performed in the CPU 10 or the like.

The storage apparatus (HDD) 14 stores an operating system (OS) and various application programs therein. Further, the storage apparatus (HOD) 14 stores table data of various parameters for the super-resolution processing and the like therein. The display apparatus 15 is a display device capable of displaying content data with a high resolution, such as a high-definition television image. Of course, the display apparatus 15 can also display content data with a low resolution lower than the content data with a high resolution, such as a high-definition television image.

FIG. 2 is a block diagram showing a functional configuration of the computer 1.

The computer 1 comprises a processing module 22, a first setting module 23, a second setting module 24, a calculation module 25, a control module 26, an output module 27, and a storage module 28.

The processing module 22 performs self-congruity point extraction processing and sharpness enhancement processing after performing the self-congruity point extraction processing. The first setting module 23 sets a group of pixels including at least one pixel of pixels contained in a reference frame as a reference block. The second setting module 24 sets pixels arranged around the reference block as a plurality of blocks comprising pixels of the same number as the number of pixels contained in the reference block to all pixels contained in the reference frame. The calculation module 25 calculates angles on which the plurality of blocks are arranged respectively on the basis of the reference block. The control module 26 controls such that processing by the processing module 22 is not applied to blocks with predetermined angles when the calculated angles are the predetermined angles (for example, values at 90 degrees intervals including zero degree) but blocks with angles other than the predetermined angles are processed by the processing module 22 when the calculated angles are angles other than the predetermined angles. The output module 27 outputs image data processed by the processing module 22 to the display apparatus 16 such as LCD. The storage module 28 stores the image data which has been applied with the super-resolution processing, and the like therein.

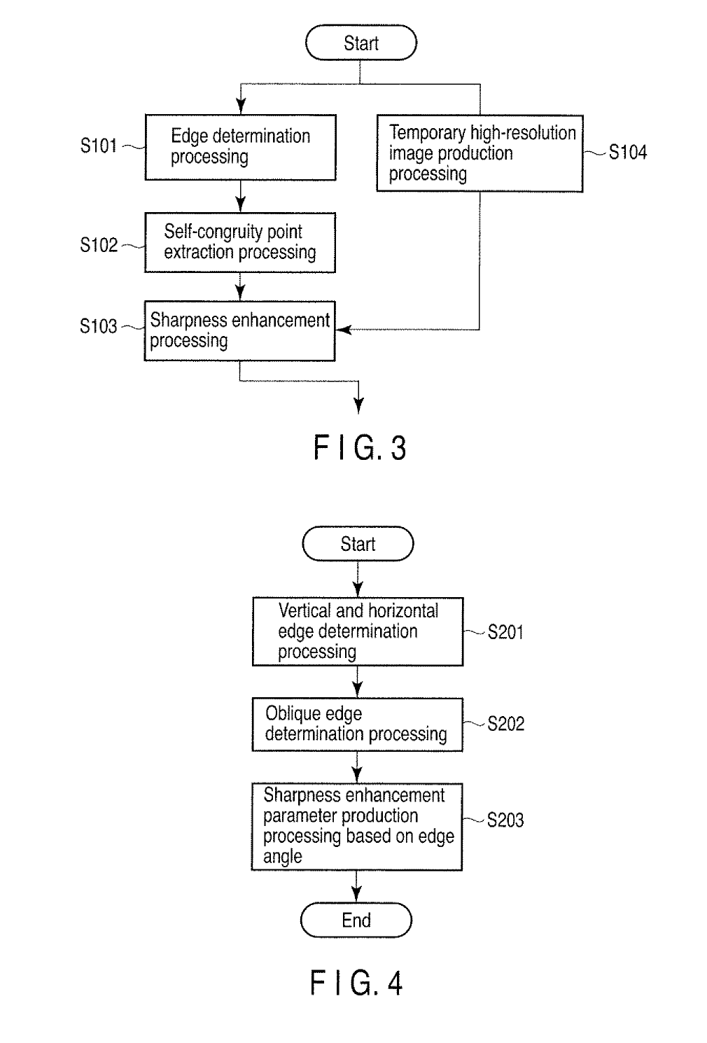

The super-resolution processing performed by the computer 1 will be explained with reference to a flowchart shown in FIG. 3. The super-resolution processing improves a resolution of input video data.

Video data input into the computer 1 is subjected to edge determination processing performed by the image processing IC 13 (block S101).

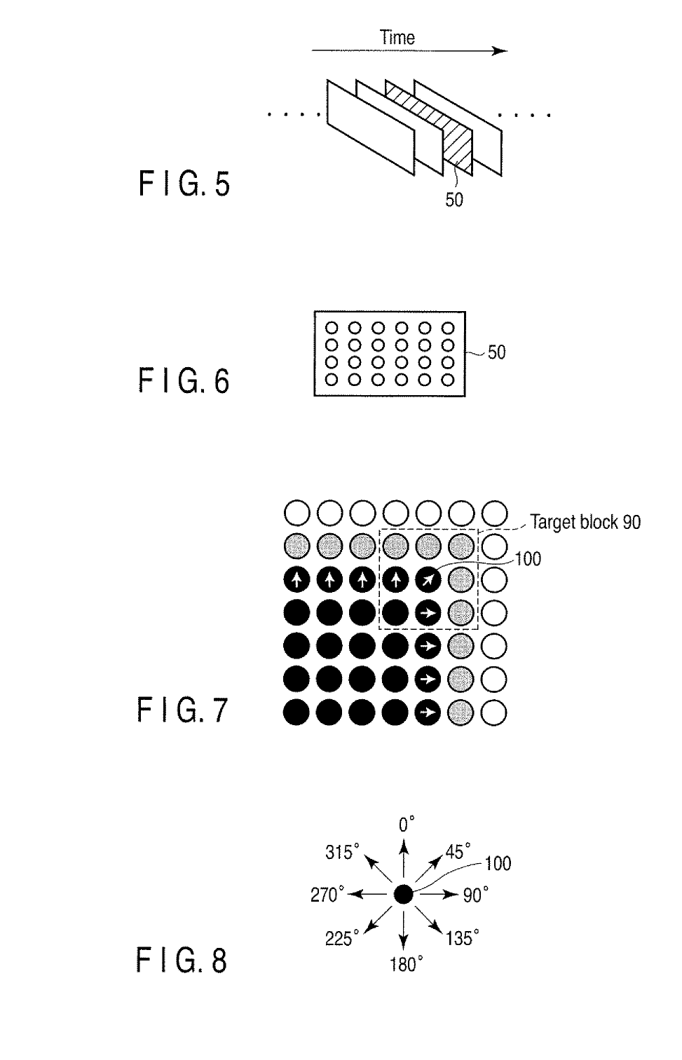

The edge determination processing is performed in the following manner. For example, a plurality of pixels are arranged within a screen of video data and an image representing luminance of each pixel as a pixel value is acquired from an image source. As shown in FIG. 5, a plurality of frames are contained in the video data. One frame is utilized as a reference frame 50 (see FIG. 5). As shown in FIG. 6, a plurality of pixels is contained in the reference frame 50.

A plurality of pixels in at least one frame contained in the video data (image source: herein, also called “image”) are sequentially set as target pixels 100, respectively (see FIG. 7). A target block (target image region) 90 including the target pixel 100 is set for the target pixel 100, so that an edge is determined (described later, see FIG. 4).

The image processing IC 13 searches for a plurality of corresponding points corresponding to a plurality of target image regions nearest a change pattern of pixel values contained in the target block 90 from the reference frame 50 to perform self-congruity point extraction processing (block S102).

After performing the self-congruity point extraction processing, the image processing IC 13 performs sharpness enhancement processing (block S103). Simultaneously, the image processing IC 13 performs temporary high-resolution image production processing (block S104). The self-congruity point extraction processing, the sharpness enhancement processing, the temporary high-resolution image production processing, and the like are explained in detail in U.S. patent application Ser. No. 11/588,219.

As is described on page 36, line 24 to page 40, line 1 of U.S. patent application Ser. No. 11/558,219, in a super-resolution processing (that is also called a super-resolution achievement processing), each temporary sampled value of each pixel in a temporary high resolution image is derived and then a processing for setting each temporary sampled value in the temporary high-resolution image closer to an exact value based on each target pixel whose edge is detected and a plurality of points corresponding to each target pixel is performed.

Regarding the sequence of processing, the number of processing times (for example, zero, twice, four times, or the like) of the self-congruity point extraction processing in block S102 and the sharpness enhancement processing in block S103 is set based upon the result of the edge determination processing which has been performed in block S101. If the number of processing times is set to zero, the self-congruity point extraction processing in block S102 and the sharpness enhancement processing in block S103 are not performed. Thereby, while suppressing degradation of image quality, the number of processing times can be reduced and the processing load can be reduced.

Thus, in this embodiment, the number of times of the sharpness enhancement processing (zero, twice, four times or the like) is changed based on the result of the edge determination processing. For example, in this embodiment, since that image deterioration will not occur even if the self-congruity point extraction processing and sharpness enhancement processing for vertical or horizontal edges are omitted, the processing load is reduced without performing the self-congruity point extraction processing and sharpness enhancement processing for vertical or horizontal edges. The self-congruity point extraction processing and sharpness enhancement processing are performed only for oblique edges other than the vertical or horizontal edges.

Next, a calculation method of the result of the edge determination processing which has been performed in block S101 will be explained with reference to a flowchart shown in FIG. 4.

As shown in FIG. 4, the image processing IC (first setting module) 13 first determines whether or not a target pixel is in a vertical or horizontal edges in an edge determination processing (block S201), determines whether or not the target pixel is in an oblique edge other than the vertical or horizontal edges (block S202), and then produces sharpness enhancement parameters (whether the self-congruity point extraction processing and sharpness enhancement processing are performed or not and the number of times of the sharpness enhancement processing) according to the angle of an edge of the target pixel (block S203). In step S203, the sharpness enhancement parameters are set so as to omit or stop execution of the self-congruity point extraction processing and sharpness enhancement processing for vertical or horizontal edges and perform the self-congruity point extraction processing and sharpness enhancement processing only for oblique edges.

The image processing IC (first setting module) 13 sets a group of pixels including at least one pixel of pixels contained in the reference frame 50 as a reference block. For example, the reference block is set to one pixel (target pixel 100). In order to determine an edge (vertical or horizontal edge or oblique edge) existing in the target pixel 100, for example, an operator of 3×3 pixels surrounded by broken lines as a target block 90 in FIG. 7 or an operator of 5×5 pixels as shown in FIG. 10 can be used.

When the operator of 3×3 pixels is used, as shown in FIG. 8, the angle of an edge can be determined at every 45 degrees, for example, at 0 degree, 45 degrees, 90 degrees, 135 degrees, 180 degrees, 225 degrees, 270 degrees and 315 degrees.

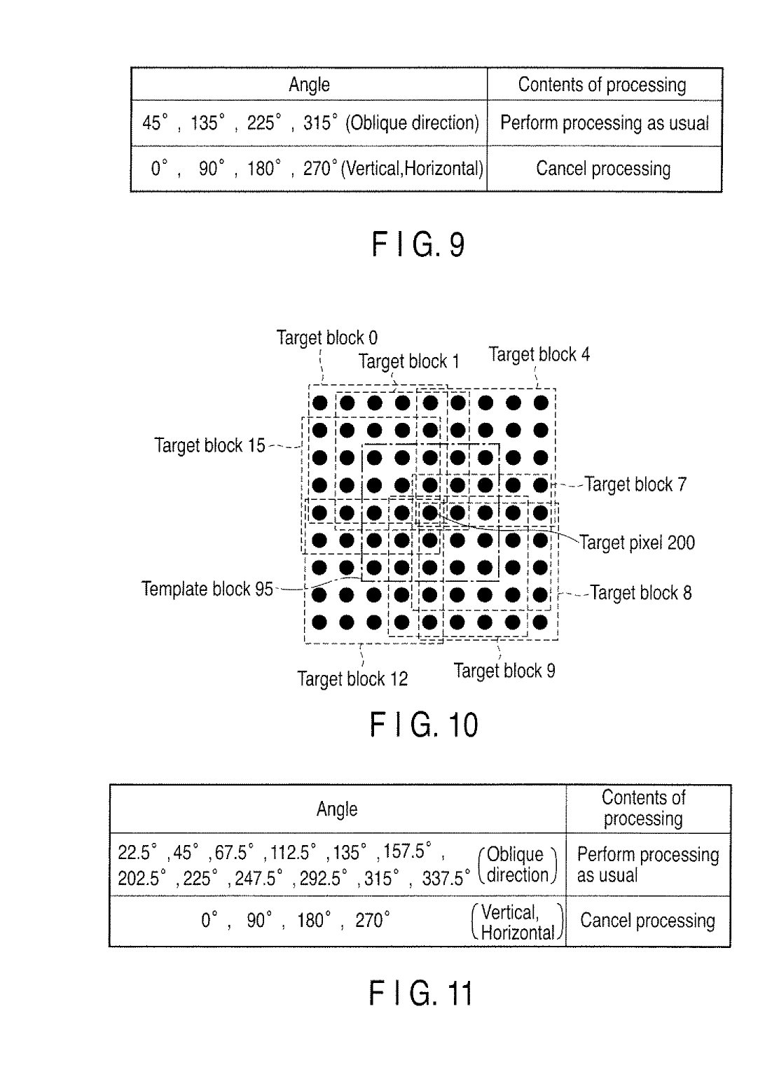

When the angles calculated by the image processing IC 13 are predetermined angles (for example, values at 90 degrees intervals including zero degree), the processing (the self-congruity point extraction processing and the sharpness enhancement processing) are not performed, but when the angles calculated by the image processing IC 13 are angles other than the predetermined angles, the processing (the self-congruity point extraction processing and the sharpness enhancement processing) are performed. For example, the predetermined angles (parameter: which is stored in the storage apparatus 14 in advance) include 0 degree and multiples of 90 degrees (90 degrees, 180 degrees, and 270 degrees: values at 90 degrees intervals, including zero degree). The self-congruity point extraction processing (block S102) and the sharpness enhancement processing (block S103) shown in FIG. 2 are not performed to a pixel with these edge angles, i.e. pixel on a vertical or horizontal edge. Even if this processing to vertical and horizontal edges is skipped, degradation of image quality does not occur so much, so that the self-congruity point extraction processing and the sharpness enhancement processing are not performed, which results in reduction of processing load. The abovementioned parameter is stored in the storage apparatus 14, for example, as shown in FIG. 9, and the image processing IC 13 determines processing content (whether or not the self-congruity point extraction processing and the sharpness enhancement processing are performed) referring to the parameter based upon determined angles (block S203). It should be noted that the number of processing times (for example, zero, twice, four times, and the like) is included in the abovementioned parameter stored in the storage apparatus 14. When the self-congruity point extraction processing and the sharpness enhancement processing are performed (for example, the calculated angles are determined to be angles other than 0 degree and multiples of 90 degrees), the sharpness enhancement processing is performed by plural times based on this parameter. For example, when the number of processing times is two, for example, the self-congruity extraction processing is performed once and the sharpness enhancement processing is performed twice.

Thus, even if the self-congruity extraction processing and the sharpness enhancement processing to the vertical and horizontal edges are skipped, degradation of image quality is suppressed so that processing load can be reduced without performing this processing.

The present invention is not limited to the above-mentioned embodiment, but may be modified as follows.

In the abovementioned embodiment, angles of edges are calculated using pixels of 3×3 surrounded by a dotted line as the target block 90, but, for example, using pixels of 5×5 surrounded by a dotted line as the target block.

For example, as shown in FIG. 10, the image processing IC 13 sets a template block 95 (corresponding to the reference block according to the abovementioned embodiment) including pixels of 5×5. A central pixel in the template block 95 is a target pixel 200.

Next, the image processing IC 13 sets pixels of 5×5 arranged around the template block 95 with the target pixel 200 being included in pixels at a boundary as target blocks 0 to 15.

Next, the image processing IC 13 compares the template block 95 and target blocks 0 to 15 to detect a target block having the same variation pattern of pixel values as the template block 95. A direction of the detected target block with regard to the template block 95 as a center is determined as the edge direction of the target pixel 200. In this case, the following angles can be determined. As shown in FIG. 11, for example, angles of 315 degrees (target block 0), 337.5 degrees (target block 1), 0 degree (target block 2), 22.5 degrees (target block 3), 45 degrees (target block 4), 67.5 degrees (target block 5), 90 degrees (target block 6), 112.5 degrees (target block 7), 135 degrees (target block 8), 157.5 degrees (target block 9), 180° (target block 10), 202.5 degrees (target block 11), 225 degrees (target block 12), 247.5 degrees (target block 13), 270 degrees (target block 14), and 292.5 degrees (target block 15) can be determined.

The abovementioned self-congruity extraction processing and sharpness enhancement processing are not performed to pixels with edge angles determined by the image processing IC 13 as 0 degree and multiples of 90 degrees (90 degrees, 180 degrees, 270 degrees), for example.

According to the modified example, determination of pixels can be performed in more detail as compared with the abovementioned embodiment, so that image quality can be improved.

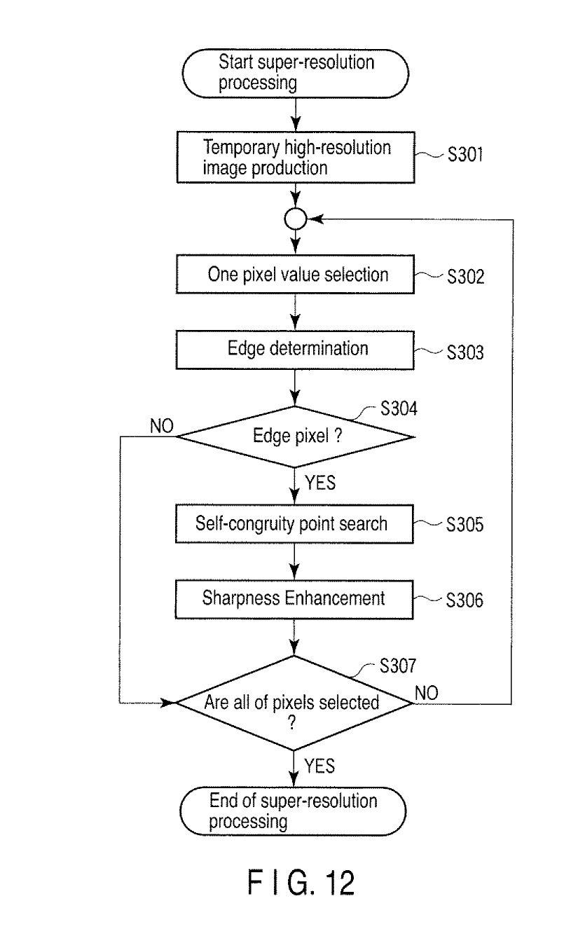

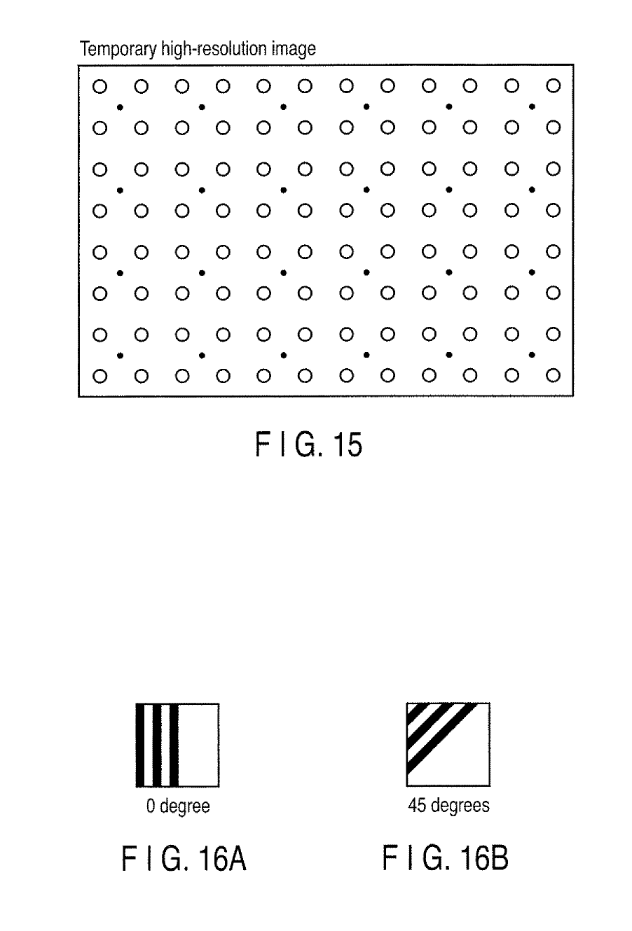

The flowchart of FIG. 12 time-sequentially shows a flow of the super-resolution processing of this embodiment. In block S301, a temporary high-resolution image of target resolution is produced based on an input low-resolution image by use of an interpolation filter (Cubic Convolution, Bi-linear or the like). An example of the temporary high-resolution image is shown in FIG. 15. The temporary high-resolution image of FIG. 15 is an image obtained by doubling the low-resolution image in the vertical and horizontal directions. In FIG. 15, white circular dots indicate pixels in the temporary high-resolution image and black circular dots indicate pixels (sampled points) in the low-resolution image used for producing pixels in the temporary high-resolution image.

In block S302, one pixel in the input low-resolution image is selected as a target pixel. In block S303, an edge determination processing for the target pixel is performed.

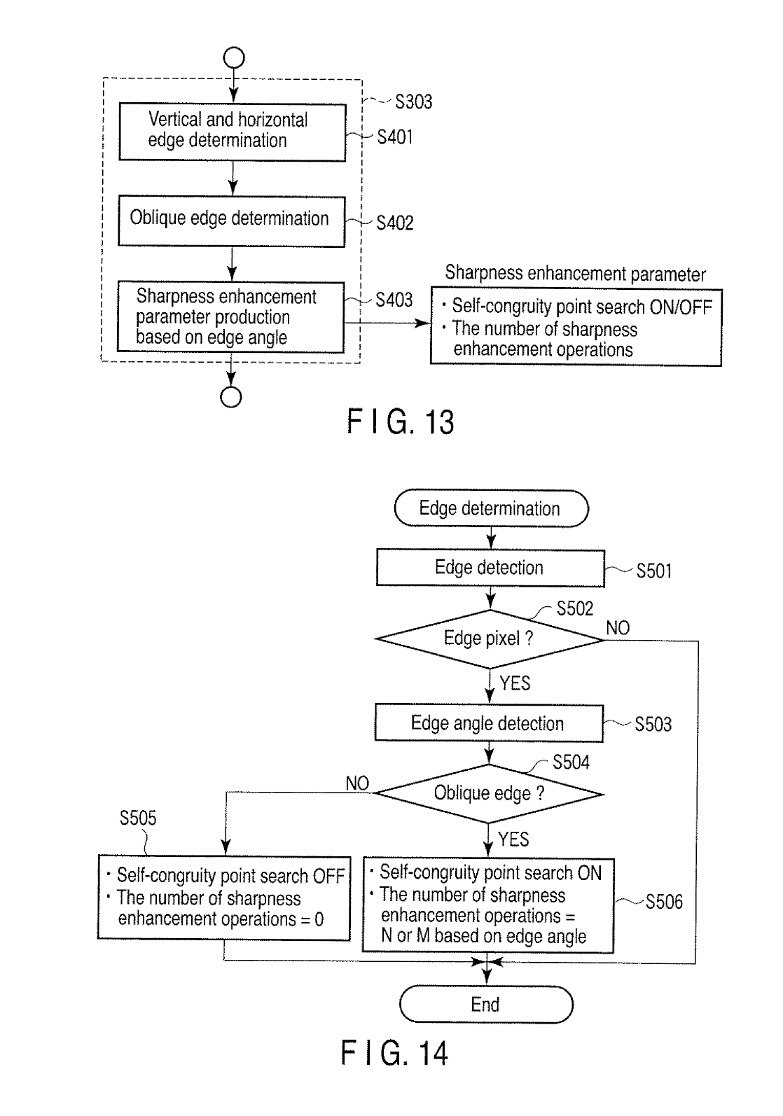

As shown in FIG. 13, in the edge determination processing, first, a vertical or horizontal edge determination processing is performed to detect whether or not an edge is present in the target pixel (block S401). An oblique edge determination processing is then performed to detect the angle of the detected edge (block S402). Subsequently, sharpness enhancement parameters (whether the self-congruity extraction processing is performed or not and the number of times of the sharpness enhancement processing) are set according to the detected angle of the edge (block S403). An example of the procedure of the edge determination processing (block S303) is shown in FIG. 14.

First, whether or not an edge is present in the target pixel is detected based on a difference between the target pixel and neighboring pixels (block S501). If an edge is detected, that is, if the target pixel is a pixel (edge pixel) lying in the edge portion (YES in block S502), the angle of the detected edge is detected in order to determine whether the detected edge is a vertical or horizontal edge or an oblique edge (block S503). For example, the edge angle of each pixel contained in the edge image of vertical stripes as shown in FIG. 16A is calculated as 0 degree. Further, the edge angle of each pixel contained in the edge image of oblique stripes as shown in FIG. 16B is calculated as 45 degrees. When the detected edge is a vertical or horizontal edge, for example, when the angle of the edge with respect to the image is 0 degree or 90 degrees (NO in block S504), it is determined that execution of the self-congruity point searching processing is omitted (the self-congruity point search OFF) and it is determined that the number of times of the sharpness enhancement processing is set to “0” (block S505). The sharpness enhancement processing is a process of correcting each pixel value (temporary sampled value) in the temporary high-resolution image corresponding to the target pixel based on a plurality of sampled values including the target pixel and a plurality of corresponding points corresponding to the target pixel. If the temporary sampled value is corrected based on a first sampled value and then the temporary sampled value is further corrected based on a second sampled value, the temporary sampled value matches the second sampled value but does not match the first sampled value. Therefore, the sharpness enhancement processing is repeatedly performed several times for all of the sampled points. By repeatedly performing the sharpness enhancement processing several times for all of the sampled points, the temporary sampled value in the temporary high-resolution image can be set closer to an exact value.

When the detected edge is an oblique edge, for example, when the angle of the edge with respect to the image is 22.5 degrees, 45 degrees, 67.5 degrees, 112.5 degrees, 315 degrees or 337.5 degrees (YES in block S504), it is determined that the self-congruity point searching processing is performed (the self-congruity point searching processing ON) and the number of times of the sharpness enhancement processing (the number of repetitive operations of the sharpness enhancement processing) is adaptively determined according to the edge angle of the oblique edge (block S506). For example, the number of times of the sharpness enhancement processing is set to N when the edge angle of the oblique edge is 22.5 degrees or 67.5 degrees and is set to M when the edge angle of the oblique edge is 45 degrees. In this case, M>N and N>1. Thus, the number of times of the sharpness enhancement processing when the edge angle of the oblique edge is 22.5 degrees or 67.5 degrees is set less than the number of the times of the sharpness enhancement processing when the edge angle of the oblique edge is 45 degrees.

Now, returning to FIG. 12, the processing after block S304 is explained. If the target pixel is at an oblique edge (YES in block S304), the self-congruity point searching processing is performed in block 5305. As described in U.S. patent application Ser. No. 11/558,219, the self-congruity point searching processing searches for a plurality of corresponding points (self-congruity points) corresponding to each target pixel on the edge portion in the low-resolution image based on the low-resolution image by paying attention to the property of the self-congruency of image in which patterns of the same intensity appear successively around the edges. In block S305, corresponding points (self-congruity points) in a plurality of image regions near a target image region which approximate a change pattern of the pixel values in the target image region containing the target pixel are searched for from the low-resolution image. Next, in block S306, the sharpness enhancement processing for correcting each pixel value in the temporary high-resolution image corresponding to the target pixel based on a plurality of sampled values containing the target pixel and a plurality of corresponding points corresponding to the target pixel is repeatedly performed. As described above, the number of repetitive operations of the sharpness enhancement processing is changed according to edge angle of the oblique edge.

If the target pixel is not at an edge or if the target pixel is at a vertical or horizontal edge (NO in block S304), the self-congruity point searching processing (block S305) and sharpness enhancement processing (block S306) are skipped.

The processing of block S302 to S306 is repeatedly performed until the processing for all of the pixels in the low-resolution image is completed.

The sharpness enhancement effect is reduced by reducing the number of times of the sharpness enhancement processing as described above, but since the processing load can be reduced accordingly, the processing load can be reduced even if the number of times of the sharpness enhancement processing for the vertical or horizontal edge is not necessarily set to “0”. For example, the number of times of the sharpness enhancement processing for the oblique edge (22.5 degrees, 45 degrees, 67.5 degrees, 112.5 degrees, 315 degrees or 337.5 degrees) may be set to M and the number of times of the sharpness enhancement processing for the vertical or horizontal edge may be set to N that is less than M.

Thus, the processing load for the vertical or horizontal edge can be reduced by changing the number of times of the sharpness enhancement processing according to the edge angle of the target pixel so as to set the number of times of the sharpness enhancement processing less when the edge of the target pixel is a vertical or horizontal edge than when the edge is an oblique edge. When the number of times of the sharpness enhancement processing for a vertical or horizontal edge is set to “0”, the self-congruity point extraction processing is also omitted.

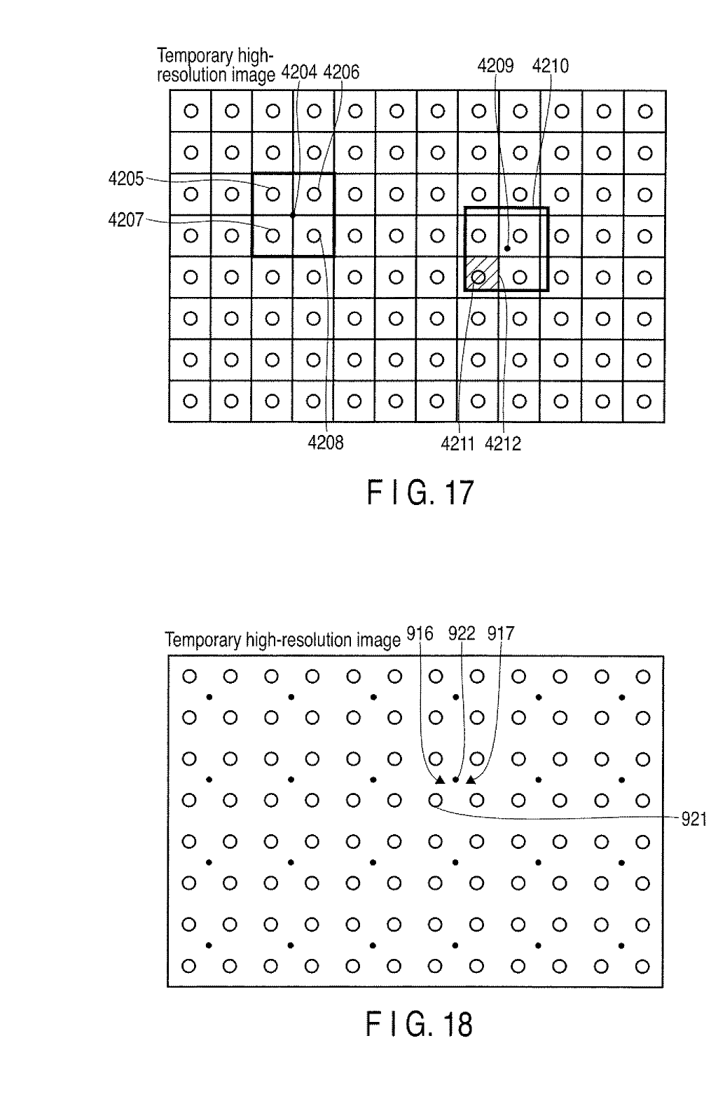

Next, the sharpness enhancement processing is explained with reference to FIG. 17. In FIG. 17, white circular dots indicate pixels of a high-resolution image and black circular dots indicate sampled points corresponding to a low-resolution image whose resolution is half of that of the high-resolution image. When temporary pixel values are given to pixels of a high-resolution image, the temporary sampled value at a sampled point 4204 is calculated as a mean value of pixel values of pixels 4205 to 4208. This occurs in a case wherein the sampled point 4204 lies exactly at the center of pixels of the high-resolution image surrounding the same. If the position of the sampled point is deviated like a sampled point 4209, a weighted average of pixel values of pixels with which a rectangle 4210 having the sampled point 4209 as the center overlaps is used as a temporary sampled value. For example, the weight for a pixel 4211 is obtained as the area of an overlapped portion 4212 indicated by oblique lines. For nine rectangles with which the rectangle 4210 overlaps, weights that are proportional to the overlapped areas are set and a weighted average is derived based on the nine pixel values and used as a temporary sampled value. If the high-resolution image obtained at this time is an accurate image, sampled values of an image photographed as a low-resolution image coincide with the temporary sampled values without fail. However, generally, they do not coincide with each other. Therefore, in order to attain the coincidence, the temporary pixel value is corrected. A difference between the sampled value and the temporary sampled value is derived and then the temporary pixel value is adjusted to eliminate the difference. Since a plurality of pixel values are provided, the difference is divided into portions according to the weights used in the sampling processing and they are added to or subtracted from the respective pixel values. This state is shown in FIG. 18. In FIG. 18, sampled points 916 and 917 indicated by black triangles are self-congruity points searched for by the self-congruity point searching processing. For example, if a pixel 921 of FIG. 18 is corrected to match the sampled value 916 and then further corrected to match a sampled value 922, it does not match the sampled value 916. Therefore, the correction processing is repeatedly performed for all of the sampled points. By repeatedly performing the correction processing, the high-resolution image is gradually set closer to a precise image.

A POCS method is proposed as one of the methods for deriving pixel values of a high-resolution image by using the pixel values of the high-resolution image as unknown values and solving a conditional expression in which a temporary sampled value obtained based on the above unknown value is equal to a sampled value of pixel values of a low-resolution image actually photographed.

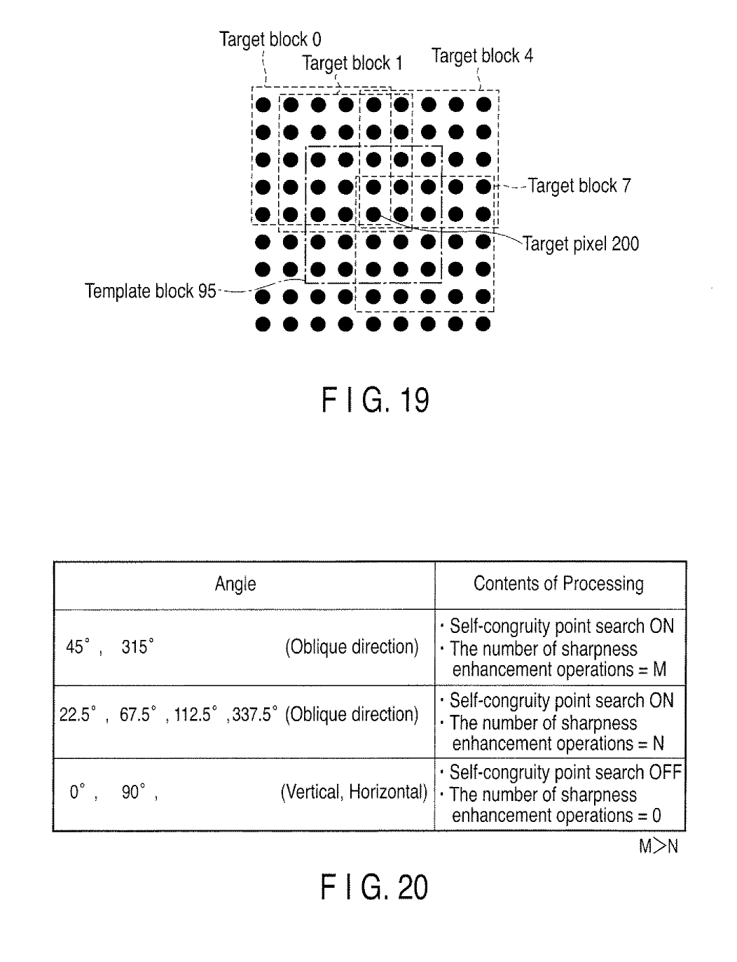

Next, an example of an edge angle calculation processing using a block of 5×5 pixels is explained with reference to FIG. 19 and FIG. 20. In this case, a block matching (difference operation or the like) is performed for the template block 95 including the target pixel 200 and each of the surrounding blocks (target blocks 0 to 7) to detect a target block having the same variation pattern of pixel values as the template block 95. A direction of the detected target block with regard to the template block 95 as a center is determined as the edge angle of the target pixel 200. In this case, the following eight directions of edge angles can be determined. Angles of 315 degrees (target block 0), 337.5 degrees (target block 1), 0 degree (target block 2), 22.5 degrees (target block 3), 45 degrees (target block 4), 67.5 degrees (target block 5), 90 degrees (target block 6), 112.5 degrees (target block 7) can be determined. As shown in FIG. 20, if the edge angle is 45 degrees or 315 degrees, it is determined to perform the self-congruity point searching processing (the self-congruity point search ON) and the number of times of the sharpness enhancement processing is set to M. If the edge angle is 22.5 degrees, 67.5 degrees, 112.5 degrees or 337.5 degrees, it is determined to perform the self-congruity point searching processing (the self-congruity point search ON) and the number of times of the sharpness enhancement processing is set to N (M>N). Further, if the edge angle is 0 degree or 90 degrees, it is determined to omit execution of the self-congruity point searching processing (the self-congruity point search OFF) and the number of times of the sharpness enhancement processing is set to “0”. Of course, as described above, it is not always necessary to set the number of times of the sharpness enhancement processing for vertical or horizontal edges to “0” and it is only necessary to set the number of times of the sharpness enhancement processing for vertical or horizontal edges less than the number of times of the sharpness enhancement processing for oblique edges.

As explained above, according to this embodiment, the self-congruity point searching processing and sharpness enhancement processing for all of the edge pixels are not performed, whether the self-congruity point searching processing and sharpness enhancement processing are performed or not or the number of repetitive operations of the sharpness enhancement processing is determined according to the edge angle of the edge pixel. As a result, the processing load of a super-resolution processing can be alleviated.

As described above, the vertical and horizontal edges are not largely influenced by the sharpness enhancement processing and the image quality will not be excessively deteriorated even if the sharpness enhancement processing for the vertical and horizontal edges is omitted. In this embodiment, since the number of times of the sharpness enhancement processing for the vertical and horizontal edges is set less than the number of times of the sharpness enhancement processing for the oblique edges, the processing load can be efficiently reduced. Further, in this embodiment, the number of times of the sharpness enhancement processing for all of the oblique edges is not set to the same value. That is, the number of times of the sharpness enhancement processing is adaptively changed according to the edge angles of the oblique edges and the processing load for the oblique edges can be efficiently reduced by setting the number of times of the sharpness enhancement processing for an oblique edge of a particular angle close to the vertical or horizontal edge (an angle closer to the vertical or horizontal direction) among the oblique edges less than the number of times of the sharpness enhancement processing for an oblique edge of another angle (an oblique edge of 45 degrees).

It should be noted that since all the procedures of the control processing of the embodiment can be accomplished by software, an effect similar to that of the embodiment can be obtained easily by simply installing a program executing this procedure in a computer having an optical disk drive provided with a power saving operation mode through a computer-readable storage medium. The abovementioned module can be accomplished as software or hardware. A module can be accomplished in software and hardware.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The various modules of the systems described herein can be implemented as software applications, hardware and/or software modules, or components on one or more computers, such as servers. While the various modules are illustrated separately, they may share some or all of the same underlying logic or code. The accompanying claims and their equivalents are intended to cover such forms or modifications as would fall within the scope and spirit of the inventions.

What is claimed is:

1. An information processing apparatus comprising:
a processor configured
to produce temporary high-resolution image data of a second resolution higher than a first resolution based on image data of the first resolution,
to sequentially set a predetermined number of pixels in the image data of the first resolution as
target pixels one by one,
to detect an edge of each target pixel, to perform a self-congruity point extraction processing for searching for corresponding points in image regions which approximate a change pattern of pixel values of a target region including the target pixel from the image data of the first resolution when the edge is detected, and
to perform a sharpness enhancement processing for the temporary high-resolution image based on the target pixel of which edge is detected and corresponding points corresponding to each target pixel of which edge is detected, and
a controller configured to control the processor not to perform the self-congruity point extraction processing and the sharpness enhancement processing when a detected edge is one of vertical and horizontal edges.

2. The apparatus of claim 1, further comprising:
a detector configured to detect an angle of the detected edge to determine whether the detected edge is one of vertical and horizontal edges or an oblique edge.

3. The apparatus of claim 1, further comprising:
a detector configured to detect an angle of the detected edge to determine whether the detected edge is one of vertical and horizontal edges or an oblique edge, wherein
the controller is configured to control the processor not to perform the self-congruity point extraction processing and the sharpness enhancement processing when the detected edge is one of vertical and horizontal edges and to control the processor to perform the self-congruity point extraction processing and the sharpness enhancement processing when the detected edge is the oblique edge.

4. An information processing apparatus comprising:
a processor configured
to produce temporary high-resolution image data of a second resolution higher than a first resolution based on image data of the first resolution,
to sequentially set a predetermined number of pixels in the image data of he first resolution as target pixels one by one,
to detect an edge of each target pixel,
to perform a self-congruity point extraction processing for searching for corresponding points in image regions which approximate a change pattern of pixel values of a target region including the target pixel from the image data of the first resolution when the edge is detected, and
to repeatedly perform a sharpness enhancement processing for the temporary high-resolution image based on the target pixel of which edge is detected and corresponding points corresponding to each target pixel of which edge is detected,
a detector configured to detect an angle of a detected edge to determine whether the detected edge is one of vertical and horizontal edges or an oblique edge, and
a controller configured to control the processor not to perform the self-congruity point extraction processing and the sharpness enhancement processing when the detected edge is the one of vertical and horizontal edges, to control the processor to perform the self-congruity point extraction processing and the sharpness enhancement processing when the detected edge is the oblique edge, and to control the processor to perform the sharpness enhancement processing by a number of times which depends on an angle of the oblique edge when the detected edge is the oblique edge.

5. An information processing apparatus comprising:
a processor configured
to produce temporary high-resolution image data of a second resolution higher than a first resolution based on image data of the first resolution,
to sequentially set a predetermined number of pixels in the image data of the first resolution as target pixels one by one,
to detect an edge of each target pixel,
to perform a self-congruity point extraction processing for searching for corresponding points in image regions which approximate a change pattern of pixel values of a target region including the target pixel from the image data of the first resolution when the edge is detected, and
to repeatedly perform a sharpness enhancement processing for the temporary high-resolution image based on the target pixel of which edge is detected and corresponding points corresponding to each target pixel of which edge is detected,
a detector configured to detect an angle of a detected edge to determine whether the detected edge is one of vertical and horizontal edges or an oblique edge, and
a controller configured to control the processor to perform the sharpness enhancement processing by a number of times which depends on an angle of the oblique edge when the detected edge is the oblique edge wherein the number of times of repetitive operations of the sharpness enhancement processing when the detected edge is the one of vertical and horizontal edges is less than the number of times of repetitive operations of the sharpness enhancement processing when the detected edge is the oblique edge.

6. An image processing method comprising:
producing temporary high-resolution image data of a second resolution higher than a first resolution based on image data of the first resolution,
sequentially setting a predetermined number of pixels in the image data of the first resolution as target pixels one by one,
detecting an edge of each target pixel,
performing a self-congruity point extraction processing for searching for corresponding points in image regions which approximate a change pattern of pixel values of a target region including the target pixel from the image data of the first resolution when the edge is detected,
performing a sharpness enhancement processing for the temporary high-resolution image based on the target pixel of which edge is detected and corresponding points corresponding to each target pixel of which edge is detected, and
stopping the performing of the self-congruity point extraction processing and the performing of the sharpness enhancement processing when a detected edge is one of vertical and horizontal edges.

7. The method of claim 6, further comprising:
detecting an angle of the detected edge to determine whether the detected edge is one of vertical and horizontal edges or an oblique edge.

8. A computer-readable storage medium configured to store program instructions for execution on a computer system enabling the computer system to perform:
producing temporary high-resolution image data of a second resolution higher than a first resolution based on image data of the first resolution,
sequentially setting a predetermined number of pixels in the image data of the first resolution as target pixels one by one,
detecting an edge of each target pixel,
performing a self-congruity point extraction processing for searching for corresponding points in image regions which approximate a change pattern of pixel values of a target region including the target pixel from the image data of the first resolution when the edge is detected,
performing a sharpness enhancement processing for the temporary high-resolution image based on the target pixel of which edge is detected and corresponding points corresponding to each target pixel of which edge is detected, and
stopping the performing of the self-congruity point extraction processing and the performing of the sharpness enhancement processing when a detected edge is one of vertical and horizontal edges.
